(19) United States
(12) Patent Application Publication
(10) Pub. No.: US 2010/0123696 A1
(43) Pub. Date: May 20, 2010

(54) IMAGE DISPLAY APPARATUS AND METHOD

(75) Inventors: Hisashi KOBIKI, Kanagawa-ken (JP); Masahiro Baba, Kanagawa-ken (JP); Goh Itoh, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/614,686

(22) Filed: Nov. 9, 2009

(30) Foreign Application Priority Data
Nov. 17, 2008 (JP) 2008-292977

(51) Int. Cl. G09G 5/10; G09G 5/00

(52) U.S. Cl. 345/207; 345/690

(57) ABSTRACT

With regard to an image to be displayed on a display unit, a calculation unit calculates a display luminance from the input image. A luminance distribution acquisition unit takes a scene image including the display unit from a view position of the display unit, and acquires a luminance distribution as an average of luminances of the scene image. A correction unit corrects the display luminance, so that a corrected display luminance is within an estimated luminance range of perceptible difference of luminances on the display unit. The estimated luminance range is estimated with the average. The display unit displays the image based on the corrected display luminance.

### CROSS-REFERENCE TO RELATED APPLICATIONS

This application is based upon and claims the benefit of priority from Japanese Patent Application No. 2008-292977, filed on Nov. 17, 2008; the entire contents of which are incorporated herein by reference.

### FIELD OF THE INVENTION

The present invention relates to an apparatus and a method for displaying an image by controlling a luminance of the image.

### BACKGROUND OF THE INVENTION

A technique to control a luminance of a display in accordance with a visual environment is well known. For example, a brightness in the visual environment (space illuminance) is acquired using two illuminance sensors (respectively set on the front of the display and the ahead of a remote controller), and a backlight of the display is controlled based on the brightness acquired. This method is disclosed in JP-A 2006-72255 (Kokai).

As to this method, the illuminance sensor can acquire only a luminous flux of nomal incident light. In this case, a radiation illuminance emitted by a light source reduces in proportion to a square of a distance. Accordingly, an illumination incident-upon the illuminance sensor largely changes based on the set position or the number of sensors, and a luminance of the backlight cannot be suitably controlled. In general, dependency relationship between the vertical luminous flux and a brightness response of an eye is low.

Furthermore, another method is disclosed in JP-A 2008-42472 (Kokai). As to this method, a detection sensor (set on the remote controller) detects a region of the display having a reflected light. By using the region extracted/discriminated from the detection information, a color and a brightness of an image (to be displayed) are corrected. Briefly, the image is corrected using only luminance information of the displaying region.

On the other hand, a luminance of a background region adjacent to the display affects on the brightness response of the eye. However, in the prior art, the luminance of the background region is not taken into consideration. Accordingly, the brightness response of the eye adopted to the visual environment cannot be sufficiently estimated. As a result, the luminance of the display cannot be suitably controlled.

### SUMMARY OF THE INVENTION

The present invention is directed to an apparatus and a method for correcting the luminance of the display by estimating a brightness response of a viewer in the environmental illumination.

According to an aspect of the present invention, there is provided an image display apparatus comprising: a display unit configured to display an image; a calculation unit configured to calculate a display luminance from an input image; a luminance distribution acquisition unit configured to take a scene image including the display unit from a view position of the display unit, and acquire a luminance distribution as an average of luminances of the scene image; and a correction unit configured to correct the display luminance, so that a corrected display luminance is within an estimated luminance range of perceptible difference of luminances on the display unit; wherein the estimated luminance range is estimated with the average, and wherein the display unit displays the image based on the corrected display luminance.

### BRIEF DESCRIPTION OF THE DRAWINGS

FIGS. 1A and 1B are schematic diagrams of use situation of the image display apparatus.

FIGS. 2A and 2B are graphs showing relationship between a space illuminance and an adaptive luminance, and relationship between a luminance distribution of wide angle and the adaptive response.

FIG. 3 is a block diagram of the image display apparatus of a first embodiment.

FIG. 4 is a flow chart of processing of the image display apparatus of the first embodiment.

FIG. 5 is a graph showing relationship between a brightness response and a display luminance.

FIG. 6 is a block diagram of the image display apparatus of a second embodiment.

FIGS. 7A and 7B are schematic diagrams of appearance of the image display apparatus of the second embodiment.

FIG. 8 is a flow chart of processing of a remote controller in the image display apparatus of the second embodiment.

FIG. 9 is a flow chart of processing of a display unit in the image display apparatus of the second embodiment.

FIG. 10 is a block diagram of the image display apparatus of a third embodiment.

FIGS. 11A and 11B are schematic diagrams of appearance of the display unit of the third embodiment.

FIG. 12 is a flow chart of processing of the image display apparatus of the third embodiment.

### DETAILED DESCRIPTION OF THE EMBODIMENTS

Hereinafter, embodiments of the present invention will be explained by referring to the drawings. The present invention is not limited to the following embodiments.

### The First Embodiment

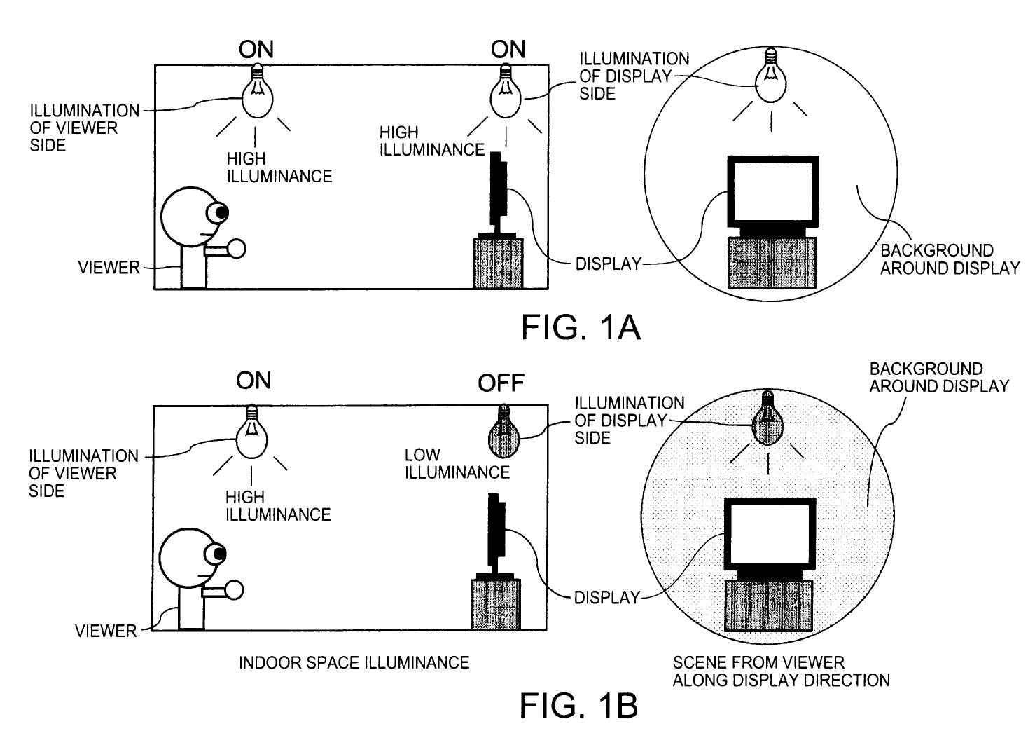

FIG. 1 shows a space illuminance which a viewer (an observer) views a display (outputting an image) in a predetermined illumination environment, and a scene which the viewer views the display. FIG. 1A is an example which an illumination adjacent to the viewer lights and an illumination adjacent to the display also lights. FIG. 1B is another example which the illumination adjacent to the viewer lights and the illumination adjacent to the display does not light.

In FIG. 1A, a wall adjacent to the display is bright because the illumination of the display side lights. In FIG. 1B, a wall adjacent to the display is dark because the illumination of the display side does not light. In the first embodiment, an average luminance (Hereinafter, it is called “luminance distribution of wide angle”) of the display and a circumference region thereof is calculated along a view direction from the viewer to the display, and a display luminance of the display is corrected based on the luminance distribution of wide angle. The luminance distribution is, in case of viewing the display from a view position (apart from the display), an average luminance of the display (panel) and the circumference region (background) thereof.

With regard to Rec.ITU-R BT.709-5 recommended by International Telecommunication Union, a standard view distance of HDTV is three times as high as the display. In case of viewing the display from a position of the standard view distance, a ratio of display (panel) field having 37 inches to the entire visual field is approximately 4%. In this case, if the display-size is changed without changing the view distance, the ratio of display field having 20 inches to the entire visual field is 1.2%, the ratio of display field having 60 inches to the entire visual field is 10.4%, and the ratio of display field having 100 inches is 29.2%. Accordingly, a ratio of display field to an entire visual field including the display and the circumference thereof is desired to be 1%˜30% of the entire visual field.

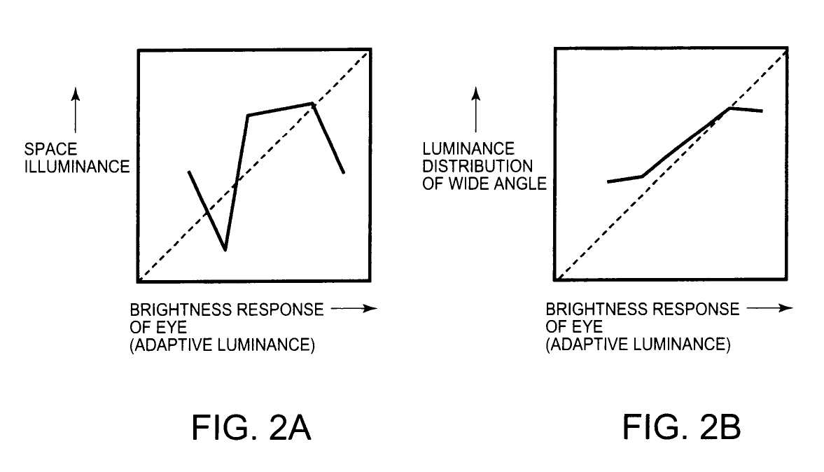

FIGS. 2A and 2b are investigation results of an adaptive luminance representing a human eye's sensitivity to brightness. In general, when the adaptive luminance is larger, the human eye has characteristics to discriminate a difference of brightness on a surface of a brighter object. FIG. 2A shows a correlation between the adaptive luminance and a space illuminance. The space illuminance is an illuminance at a viewer's position. In FIG. 1, an illumination adjacent to the viewer largely affects on the space illuminance. FIG. 2B shows a correlative relationship between the adaptive luminance and the luminance distribution of wide angle.

As shown in FIGS. 2A and 2B, a correlation between the adaptive luminance and the space illumination is low, but a correlation between the adaptive luminance and the luminance distribution of wide angle is high. Accordingly, in the first embodiment, the adaptive luminance of human eye is estimated from the luminance distribution of wide angle, and an image having a corrected luminance based on the adaptive luminance is displayed. Hereinafter, the image display apparatus 10 of the first embodiment is explained.

(1) Component of the Image Display Apparatus 10:

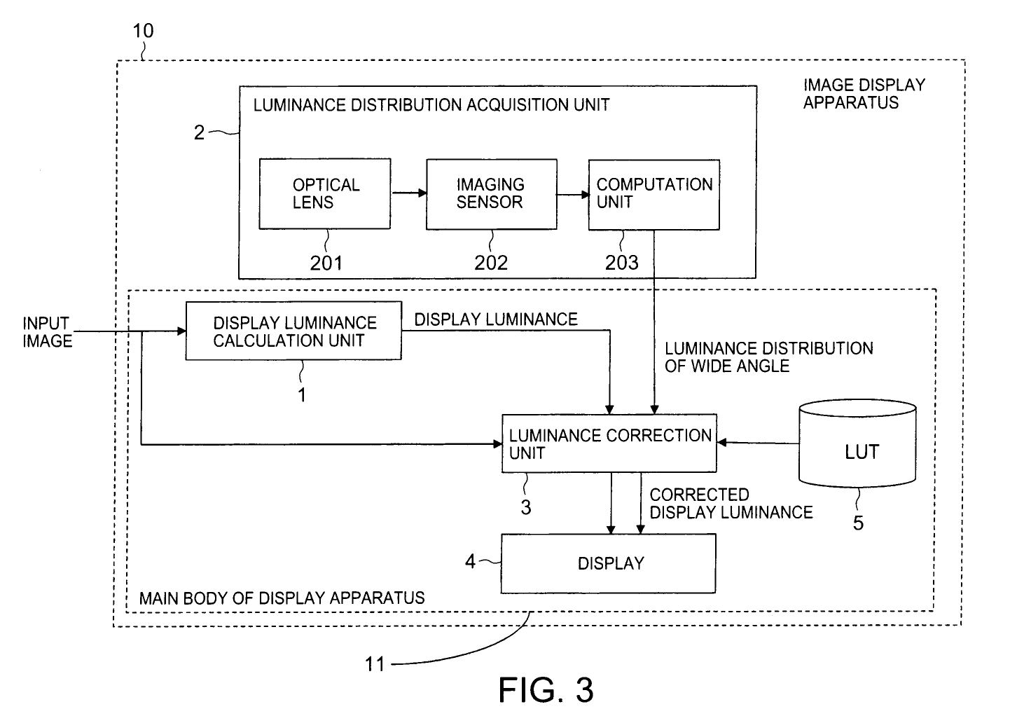

FIG. 3 is a block diagram of the image display apparatus 10 of the first embodiment. The image display apparatus 10 includes a display luminance calculation unit 1, a luminance distribution acquisition unit 2, a luminance correction unit 3, and a display 4. In the image display apparatus 10, the display luminance calculation unit 1, the luminance correction unit 3 and the display 4, form a main body 11 of display apparatus. In the first embodiment, the luminance distribution acquisition unit 2 can communicate with the main body 11 wirelessly or wirely, which is separate from the main body 11 physically.

The display luminance calculation unit 1 inputs a video signal (Hereinafter, it is called “input image”) having digital or analog format from the outside of the image display apparatus 10, and calculates a luminance (Hereinafter, it is called “display luminance”) of the input image to be actually displayed on the display 4. The input image has general image information such as a luminance and a chromaticness.

The display 4 includes a panel to display the input image based on the video signal, and a control unit to control the panel. Concretely, the display 4 may be any of a CRT display, a liquid crystal display, a plasma display, an organic EL display, and another display. The display 4 desired to display pixels each having the luminance within 0.01 [cd/m²]˜2000 [cd/m²].

The luminance distribution acquisition unit 2 is located at a position to view the display 4, and acquires a luminance distribution of wide angle along a direction from the position to the display 4. As shown in FIG. 3, the luminance distribution acquisition unit 2 includes an optical lens 201 to focus an incident light, an imaging sensor 202 having at least one light-receiving element (such as CCD or CMOS) arrayed, and a computation unit 203 to compute a luminance value from an output current of the imaging sensor. The optical lens 201 focuses a light incident from a wide angle. The imaging sensor 202 takes a light focused by the optical lens 201, and photoelectrically transfers the light. The computation unit 203 computes a luminance distribution of wide angle from an output current supplied by the imaging sensor 202. A spectral sensitivity characteristics of the light-receiving element of the imaging sensor is desired to be near a standard spectral luminous efficiency V(λ) fixed by JIS C7612. However, the spectral sensitivity characteristics may be near a desired standard spectral luminous efficiency by using a color-filter or a response difference. The optical lens may be replaced with a focus means such as a pin-hole structure or a plural lens structure having the focal distance adjusted.

Furthermore, when an angle between a view direction (from the viewer to the display 4) and a normal line direction of the display 4 (panel) is above ±45 deg along horizontal and vertical directions, a space coordinate of the luminance distribution of wide angle is transferred using a distance between the viewer and the display 4, and horizontal and vertical visual angles of the display 4. In this case, the luminance distribution of wide angle can be calculated in the same way as the case that the viewer views the display 4 along the normal line direction. Briefly, a part of function of a general purpose device (a digital still-camera or a cellular-phone) having above-mentioned characteristics may be alternatively used.

The luminance correction unit 3 corrects the display luminance (calculated by the display luminance calculation unit 1) using the luminance distribution of wide angle (acquired by the luminance distribution acquisition unit 2). A method for calculating a corrected display luminance is explained in detail afterwards. A LUT 5 stores a data set necessary to correct the display luminance in correspondence with the luminance distribution of wide angle. The data set is explained in detail afterwards.

(2) Operation of the Image Display Apparatus:

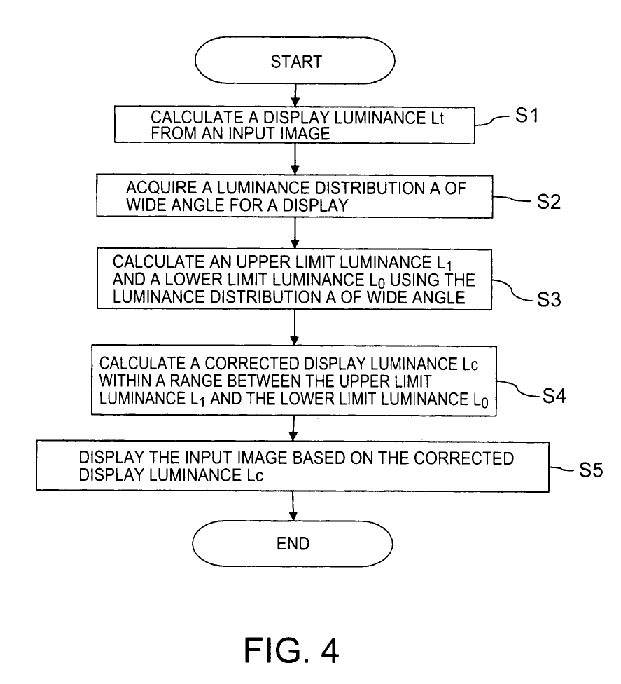

FIG. 4 is a flow chart of processing of the image display apparatus 10. First, the display luminance calculation unit 1 calculates a display luminance Lₜ [cd/m²] (Hereinafter, this unit is omitted) of each pixel from the image (input to the image display apparatus 10) (S1). Concretely, the display luminance calculation unit 1 calculates the display luminance Lₜ of each pixel (to be displayed on the display 4) from the input video signal. The display luminance Lₜ is a luminance value to which gamma-conversion to display the image is performed. In this case, the display luminance Lₜ of each pixel is previously corrected to be equal to a luminance value actually measured.

Next, the luminance distribution acquisition unit 2 takes an image from a set position (able to image the display 4) along a direction to the display 4, and acquires a luminance distribution A of wide angle (S2). In the first embodiment, a light amount via the lens is detected at a predetermined interval, and an absolute luminance of each pixel is calculated from the light amount acquired by each light-receiving element of the imaging sensor 202. The luminance distribution A of wide angle may be acquired by the viewer's indication.

Hereinafter, a method for calculating an absolute luminance of a surface of the object from the light amount (incident on the imaging sensor 202) is explained. First, in case of imaging mechanism having auto exposure function, under a condition excluding influence of gamma-conversion, a relationship between the light amount (incident on the imaging sensor 202) and the luminance of the surface of the object is represented as an equation (1) by APEX (Additive system of Photographic Exposure, which was proposed in the 1960 American Standards Association) standard value.

log 2(B/3.42)=2×log 2F−log 2T−log 2(S/3.125) (1)

In the equation (1), “B” is a coefficient to correct the luminance, “F” is a stop value (F value), “T” is a shutter speed (sec), and “S” is ISO sensitivity. In general, “F, T, S” are determined by Through-the-lens type exposure meter inside the camera, and preset so that a metering point has 18% gray. Accordingly, each pixel value (x, y) of the image is converted by an equation (2).

Labs(x,y)=100×B×Y(x,y)/(18×Ymax) (2)

In the equation (2), “Lab (x, y)” is an absolute luminance [cd/m²] of light received by the light-receiving element (x, y), “Y (x, y)” is a gradation value of the image, and “Ymax” is a maximum value (100 as a regular value) in CIE1931XYZ color system. By above-mentioned luminance value, a gradation value Y (x, y) of each pixel is converted. Furthermore, by averaging the absolute luminance Labs (x, y) acquired by all light-receiving elements, a luminance distribution A [cd/m²] of wide angle along a direction from the viewer to the display can be acquired.

In the first embodiment, in case of viewing from the view position to the display 4 while fixing “F, T, S”, an entire viewing field including the display 4 and a circumference thereof is taken as a scene image. After that, a luminance value output from each light-receiving element is corrected by a point spread function (PSF) of the lens, the luminance distribution A of wide angle is calculated by averaging the absolute luminance Labs (x, y) (acquired by each light-receiving element) and temporally stored. When the luminance distribution A of wide angle from the absolute luminance Labs (x, y), in addition to PSF, by setting a weight to Labs (x, y), the luminance distribution A of wide angle may be calculated as a weighted average.

In an image estimated as a surface of the display 4, a smaller weight is set to the luminance value output from light-receiving elements corresponding to a center region of the image, a larger weight is set to the luminance value output from light-receiving elements corresponding to a circumference region of the image, and the luminance distribution A of wide angle may be calculated using the weighted average. By above-mentioned weighting, the luminance distribution A of wide angle having the large weight set to luminances corresponding to a background of the display 4 is calculated.

Next, by using the luminance distribution A acquired at S2, the luminance correction unit 3 respectively calculates an upper limit luminance and a lower limit luminance of a perception range of eye's brightness response (S3). Relationship among a brightness response, the display luminance and the luminance distribution A of wide angle, is represented as an equation (3).

R=Rₘ×Lₜⁿ/(Lₜⁿ+Aⁿ) (3)

In the equation (3), “n” is a constant within “0.7˜2.0”, which becomes a larger value when the luminance distribution A of wide angle is larger. “Rₘ” is a coefficient of brightness response as a constant based on the luminance distribution A of wide angle. In the first embodiment, a data set of values of “Rₘ and n” in correspondence with the luminance distribution A of wide angle is stored in the LUT 5 to be referred.

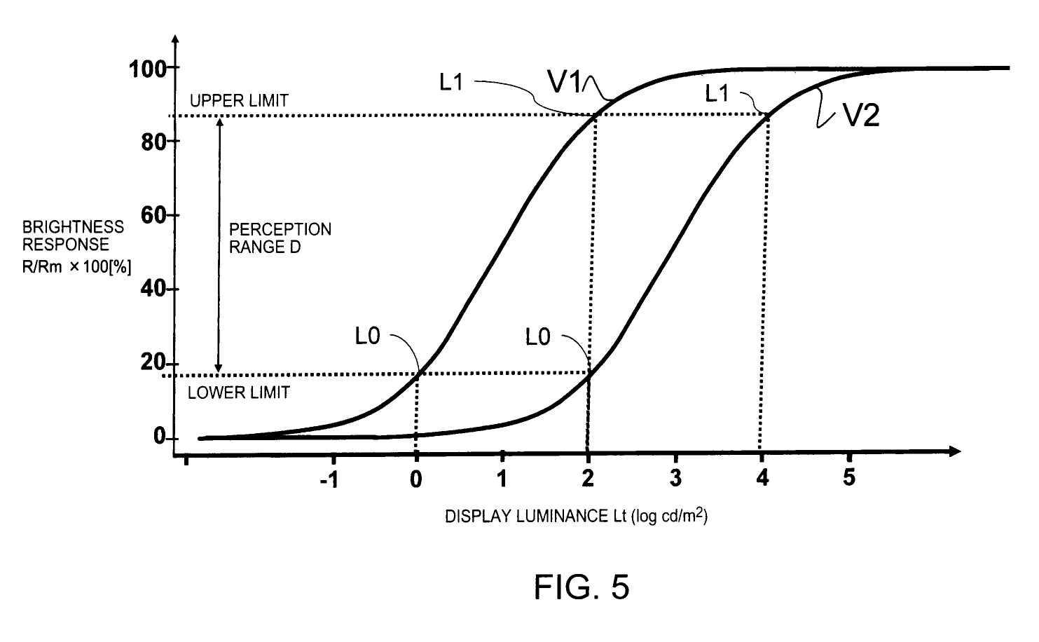

FIG. 5 shows an example of a brightness response curve of the equation (3). In FIG. 5, a horizontal axis represents the display luminance Lₜ, and a vertical axis represents the brightness response R normalized by each Rₘ. The brightness response curve is V1 in case that the luminance distribution A of wide angle is 10 [cd/m²], and the brightness response curve is V2 in case that the luminance distribution A of wide angle is 100 [cd/m²]. In this case, an upper limit Rₘₐₓ/Rₘ of the brightness response is 86%, and a lower limit Rₘᵢₙ/Rₘ of the brightness response is 17%. A range “17%˜86%” of the brightness response is a brightness perception range D. In other words, if the image is displayed with a luminance over the brightness perception range D, the viewer cannot perceive a difference of the luminance of the image displayed. For example, as to the brightness response curve V1, pixels displayed with the luminance below 1 [cd/m²] are perceived as black pixels by the viewer. In the same way, pixels displayed with the luminance above 100 [cd/m²] are perceived as white pixels by the viewer.

The upper limit luminance L₁ and the lower limit luminance L₀, which corresponds to an upper limit Rₘₐₓ and a lower limit Rₘᵢₙ of the brightness response R respectively, are calculated by equations (4) and (5) each transformed from the equation (3). In the first embodiment, the upper limit Rₘₐₓ/Rₘ and the lower limit Rₘᵢₙ/Rₘ of the brightness response R is previously determined.

$$\begin{matrix}{L}_{0} = \frac{A}{{\{ ( {R}_{m} / {R}_{m i n} ) - 1 \}}^{1 / n}} & ( 4 ) \\ {L}_{1} = \frac{A}{{\{ ( {R}_{m} / {R}_{m ax} ) - 1 \}}^{1 / n}} & ( 5 )\end{matrix}$$

Next, the luminance correction unit 3 corrects a luminance value Lₜ of the input image so that a corrected luminance value is within a range between the upper limit L₁ and the lower limit L₀, and generates the corrected display luminance L_{c} (S4). The corrected display luminance L_{c} is calculated by an equation (6).

L_{c}=L₁×(Lₜ−L₀)/(L₁−L₀) (6)

In this case, the corrected display luminance L_{c} of all pixels in the input image is calculated. A method for calculating the corrected display luminance is not limited to the equation (6). Briefly, the luminance value is corrected to be within the perception range. Last, the display 4 displays the image based on the corrected display luminance L_{c} (calculated at S4) and a chromaticness of the input video signal (S5).

As mentioned-above, by displaying the image having the corrected luminance within the perception range of eye's brightness response at S5, a contrast of the luminance perceived by the viewer rises. Furthermore, the image having smooth gradient without jump and clipping is displayed. Briefly, according to the image display apparatus of the first embodiment, a luminance range corresponding to the perception range of eye's brightness response is estimated using the luminance distribution of wide angle having high correlation with the eye's brightness response. Accordingly, the eye's brightness response is adaptively estimated, and the display luminance is suitably controlled for the human vision.

### The Second Embodiment

An image display system 20 of the second embodiment is explained.

(1) Component of the Image Display System 20:

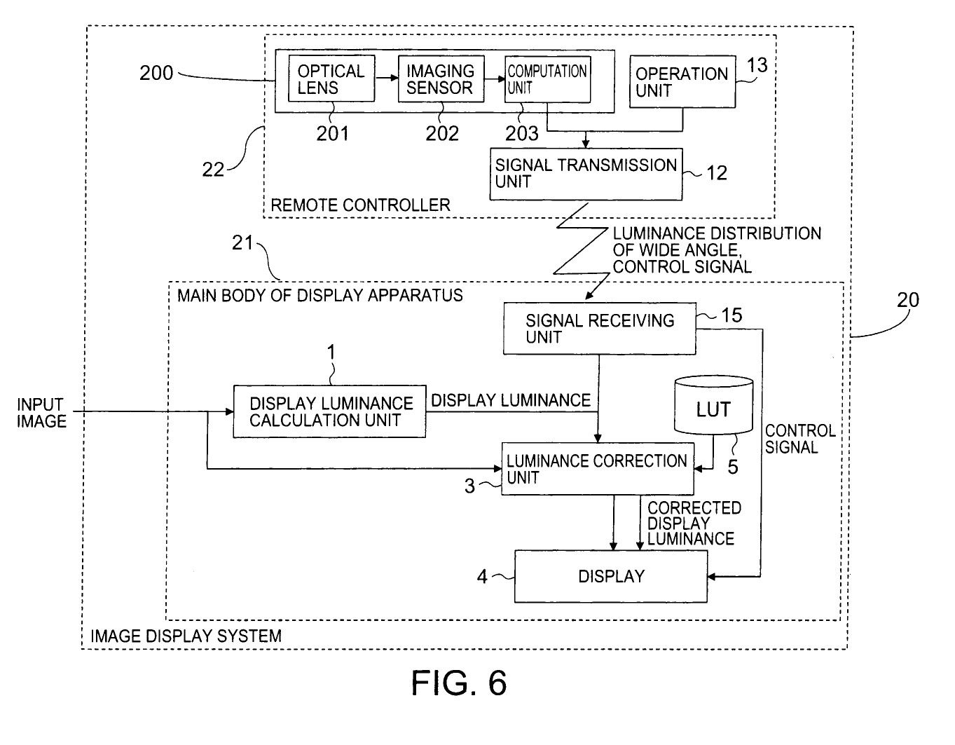

FIG. 6 is a block diagram of the image display system 20. The image display system 20 includes a main body 21 of display apparatus, and a remote controller 22. The main body 21 of display apparatus wirelessly communicates with the remote controller 22. The main body 21 of display apparatus includes the display luminance calculation unit 1, the luminance correction unit 3, the display 4, and a signal receiving unit 15.

In order to control a display luminance, if the luminance is automatically controlled at a predetermined interval or a random interval, a viewer is apt to become aware of change of the display luminance, and this change gives unnatural impression to the viewer. As to the image display apparatus of the second embodiment, by correcting the display luminance in synchronization with active control operation (such as a channel operation, timing of power-on or power-off), the display luminance is changed at a timing hard for the viewer to perceive the change of luminance.

The signal receiving unit 15 includes wireless communication means such as infrared rays or Bluetooth®, which is set on the front of the display 4 of the main body 21. The remote controller 22 includes a luminance distribution acquisition unit 200, an operation unit 13, and a signal transmission unit 12. The signal transmission unit 12 has the same wireless communication means as the signal receiving unit 15, which is set on the front of the remote controller 22. The operation unit 13 has an interface for the viewer to input a control signal of the display apparatus. For example, the operation unit 13 has a channel and a switch to control a volume or a power, as the interface for the viewer to operate the display apparatus.

In the same way as the first embodiment, the luminance distribution acquisition unit 200 has an optical lens 201, an imaging sensor 202, and a computation unit 203. The luminance distribution unit 200 is set on the front of the remote controller 22, i.e., on the same face where the signal transmission unit 12 is set. When the viewer operates (to display, output speech, or broadcast data) the main body 21 of display apparatus by the remote controller 22 in his/her hand, the signal transmission unit 12 often turns to a direction toward the display 4. Accordingly, the luminance distribution acquisition unit 200 is located on the same front where the signal transmission unit 12. In this case, the luminance distribution acquisition unit 200 takes an image of a scene which the viewer views along a direction toward the display 4, and acquires a luminance distribution of wide angle by averaging luminance of the image. Furthermore, the viewer's intentional operation (of the operation unit 22) to acquire the luminance distribution of wide angle greatly reduces. As a result, brightness data of a background of the display 4 from the viewer's position can be accurately acquired.

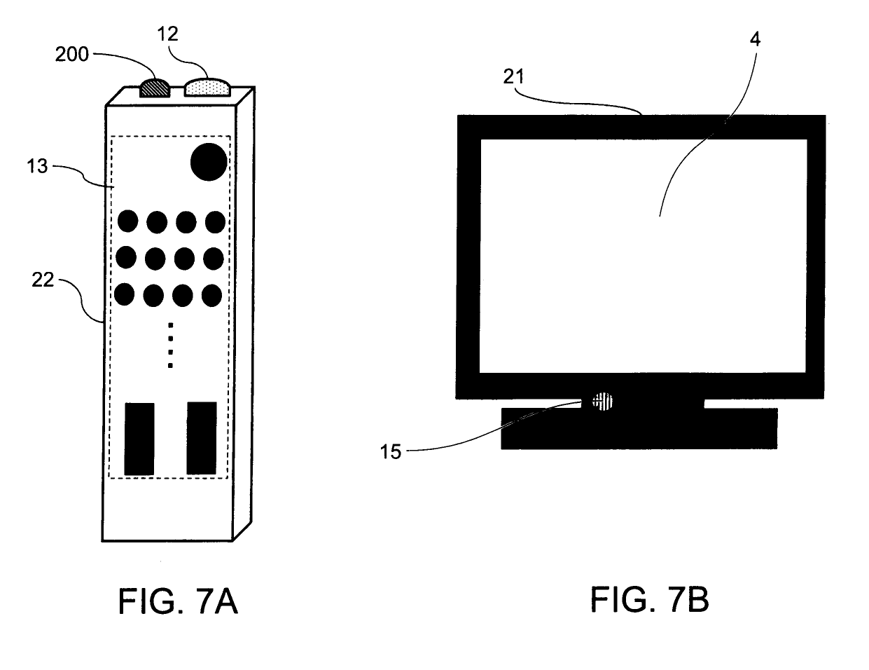

FIGS. 7A and 7B show an example of appearance of the image display system 20. FIG. 7A shows appearance of the remote controller 22, and FIG. 7B shows appearance of the main body 21 of display apparatus. As shown in FIGS. 7A and 7B, the luminance distribution acquisition unit 200 and the signal transmission unit 12 are located on the same face of the remote controller 22, and the signal receiving unit 15 and the display 4 are located on the same face of the main body 21 of display apparatus.

When the viewer operates the remote controller 22, a face where the signal transmission unit 12 is set in the remote controller 22 is turned to the signal receiving unit 15 of the main body 21 of display apparatus. Accordingly, the luminance distribution acquisition unit 200 takes an image of a scene along a view direction from the viewer to the display 4 at a timing to operate the operation unit 13, and calculates a luminance distribution A of wide angle by averaging the luminance of the image.

(2) Operation of the Image Display System:

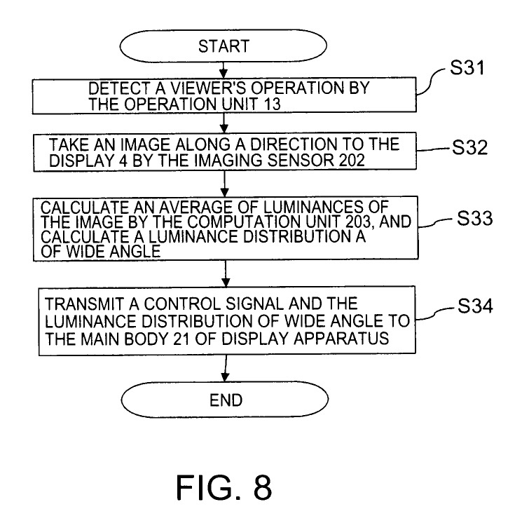

FIG. 8 is a flow chart of processing of the remote controller 22. First, the remote controller 22 detects the viewer's operation of the operation unit 13 (S31). The operation unit 13 notifies the luminance distribution unit 200 of the viewer's operation.

Next, the imaging sensor 202 of the luminance distribution acquisition unit 200 takes a scene image in synchronization with the timing for the viewer to operate (input by a button) the operation unit 13 (S32). For example, by acquiring the luminance distribution A of wide angle immediately after pushing a button of the remote controller 22, a scene along a view direction from the viewer to the display 4 corresponds to the luminance distribution A of wide angle acquired from a scene image which the remote controller 22 is turned to the display 4.

Next, the computation unit 203 calculates a luminance distribution A of wide angle from the luminance of the scene image taken by the imaging sensor 202 (S33). In the second embodiment, the computation unit 203 of the remote controller 22 calculates the luminance distribution A of wide angle. However, by transmitting the scene image (two-dimensional information) having luminance values taken from the imaging sensor 202 to the main body 21 of display apparatus, the main body 21 may calculate an average of the luminance values. As a result, a circuit-scale of a micro computer of the luminance distribution acquisition unit 200 is reduced, and a price unit for manufacture can be lowered. In this case, data amount transmitted from the remote controller 22 to the main body 21 increases.

Next, the signal transmission unit 12 wirelessly transmits a control signal (from the operation unit 13 in response to the viewer's operation) and a signal of the luminance distribution A of wide angle (acquired by the luminance distribution acquisition unit 200) to the main body 21 of display apparatus. In this case, any of the control signal and the luminance distribution signal may be preferentially transmitted in a transmission time. However, by comparing an operation period to execute the control signal with an operation period to calculate a corrected display luminance L_{c} based on the luminance distribution signal, one signal having a longer operation period is desired to be transmitted first.

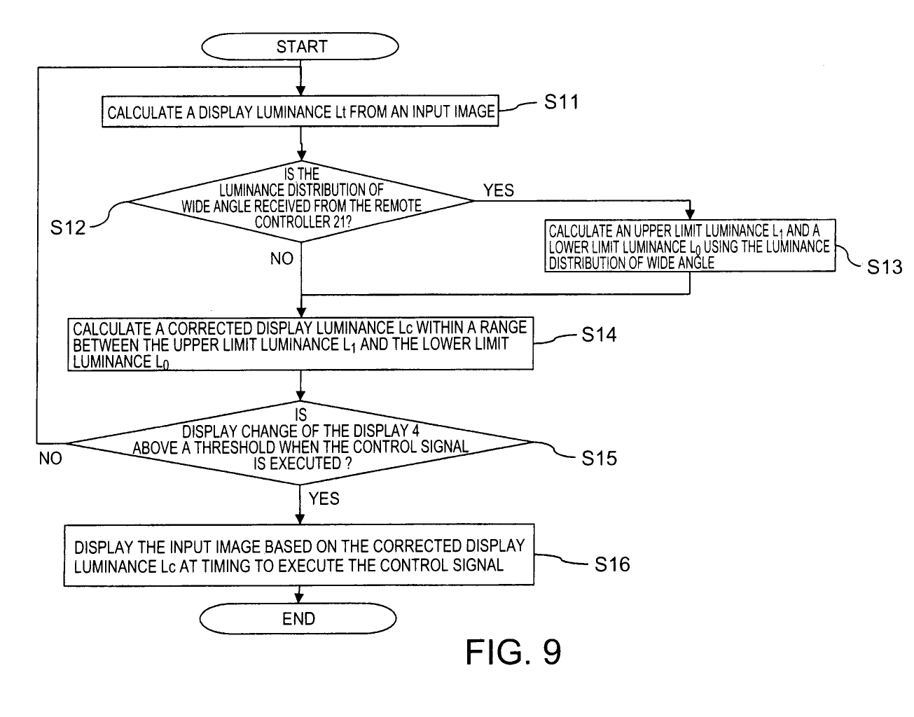

FIG. 9 is a flow chart of processing of the main body 21 of display apparatus. In FIG. 9, S11, S13 and S14 are respectively same as S1, S3 and S4 of FIG. 4. Accordingly, explanation of S11, S13 and S14 is omitted.

First, the signal receiving unit 15 decides whether a luminance distribution signal is received from the remote controller 22 (S12). If it is decided that the luminance distribution signal is received (Yes at S12), processing is forwarded to S13.

Next, when a control unit (not shown in FIG. 6) of the display 4 executes the control signal, it is decided whether a display change of the display 4 is above a threshold (predetermined standard) (S15). If the display change is above the threshold (Yes at S15), processing is forwarded to S16. Briefly, by controlling the display luminance in synchronization with a timing when the display change on the display 4 is large, it is hard for the viewer to perceive change of the display luminance. As a control operation to largely change the display contents, a switching operation of channel, a start of transmission/receiving of data broadcast, and power on/off of the main body 21 of display apparatus, are considered. For example, control of the volume is not an operation to change the display. In this case, the display luminance may not be changed at the timing to control the volume.

Last, a timing to execute the control signal is synchronized with a timing to display the image based on the corrected display luminance L_{c} (S16). In the second embodiment, after calculating the corrected display luminance L_{c}, display change of the display 4 is decided at S15. However, in order to reduce the computation amount, processing of S15 may be inserted between S12 and S13. Furthermore, only when an input using a predetermined button is operated in the operation unit 13 of the remote controller 22, the imaging sensor 202 may take the scene image.

### The Third Embodiment

An image display system 30 of the third embodiment is explained.

(1) Component of the Image Display System 30:

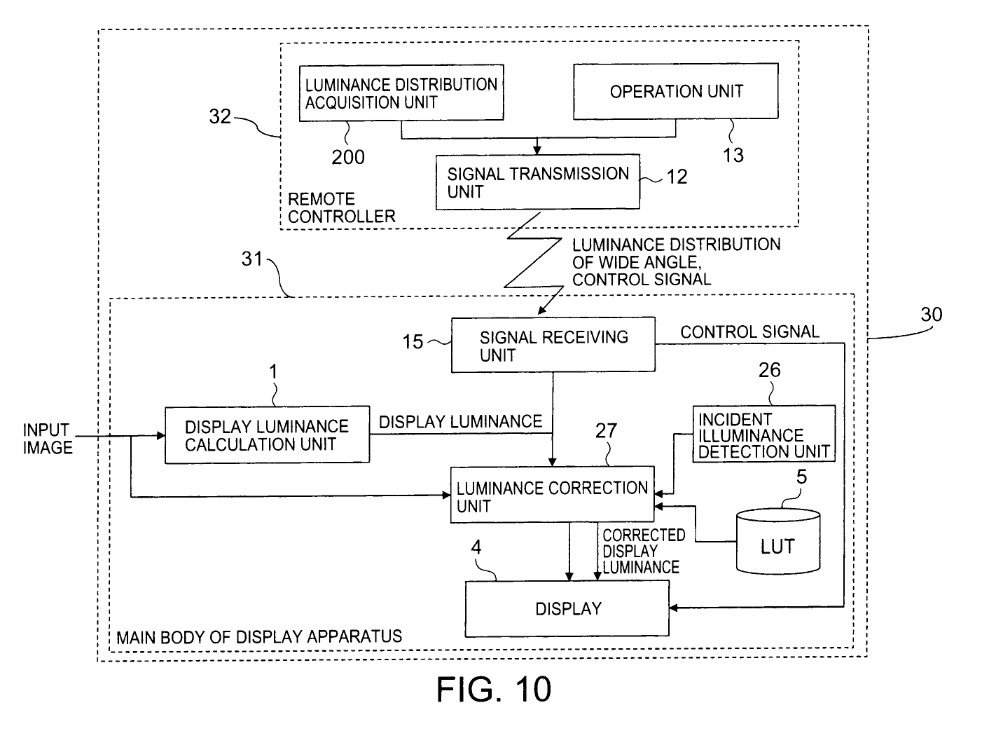

FIG. 10 is a block diagram of the image display system 30 of the third embodiment. In comparison with the image display system 20 of FIG. 6, the image display system 30 further includes an incident illuminance detection unit 26. The incident illuminance detection unit 26 includes an illuminance sensor and various kinds of control circuit, and detects an illuminance of an environmental light incident from the outside of the image display system 30. Furthermore, the incident illuminance detection unit 26 calculates a surface reflection luminance of the display 4 from the illuminance.

A luminance correction unit 27 calculates a corrected display luminance using the display luminance (calculated by the display luminance calculation unit 1), the luminance distribution A of wide angle (received by the signal receiving unit 15) and an incident illuminance signal (detected by the incident illuminance detection unit 26). Concretely, the luminance correction unit 27 prepares a program to calculate the corrected display luminance and another computation unit.

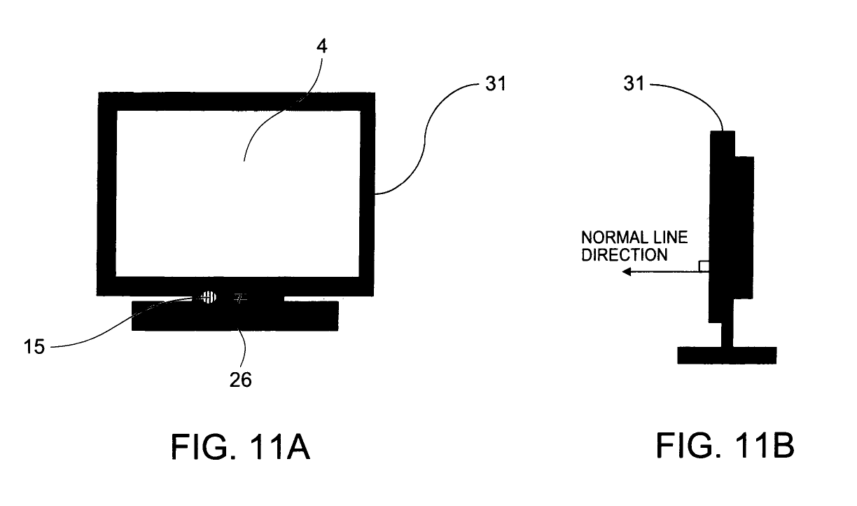

FIGS. 11A and 11B show appearance of the main body 31 of display apparatus. FIG. 11A shows appearance of a front view of the main body 31. FIG. 11B shows appearance of a side view of the main body 31. The incident illuminance detection unit 26 is located on the same surface as a panel (screen) of the display 4. In order to exactly calculate the surface reflection luminance, the illuminance sensor is desired to be located so that a normal line direction of the display 4 is equal to a normal line direction of a light-receiving surface of the illuminance sensor of the incident illuminance detection unit 26.

(2) Operation of the Image Display System 30:

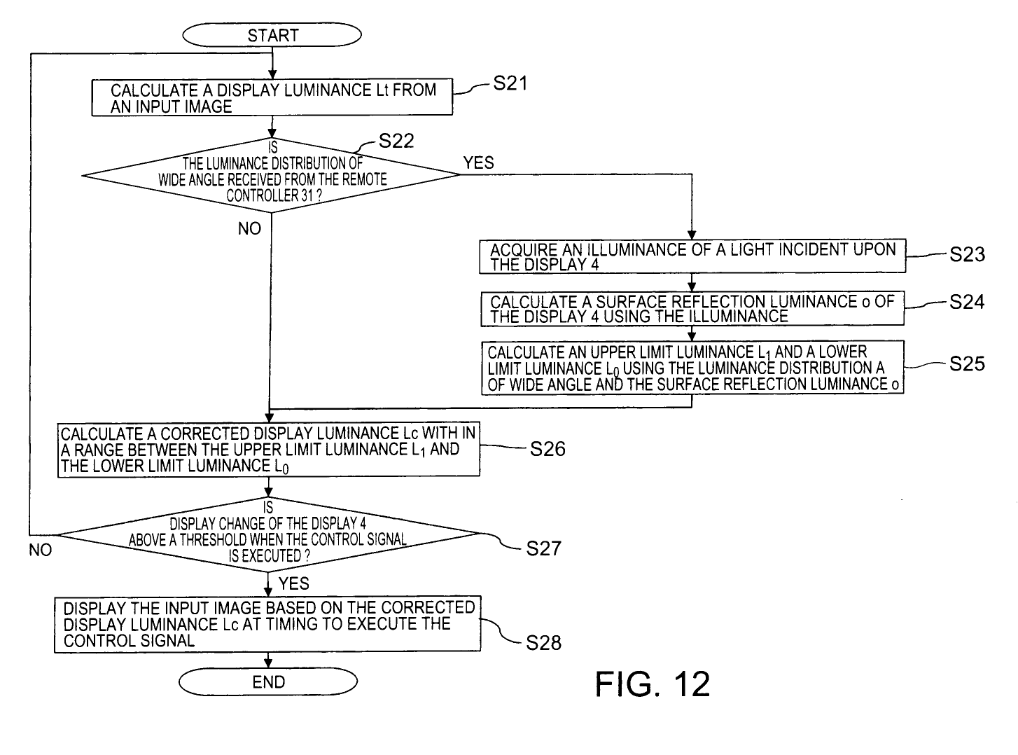

Next, operation of the image display system 30 of the third embodiment is explained by referring to FIG. 12. FIG. 12 is a flow chart of processing of the image display system 30. In FIG. 12, S21, S22, S26, S27 and S28 are respectively same as S11, S12, 514, S15 and S16 of FIG. 9. Accordingly, explanation of S21, S22, S26, S27 and S28 is omitted.

The incident illuminance detection unit 26 detects an incident illuminance E [1×] of the environmental light incident upon the display 4 (S23). In this case, the incident illuminance is desired to be detected at a timing to operate the display 4 by the remote controller. As a result, when the channel of the remote controller is operated, a light amount of the environmental light incident upon the display 4 can be detected at once. The incident illuminance may be detected at a predetermined interval or a random interval. In this case, an illuminance detected at a time near the operation timing (by the remote controller 32) is desired to be used as the incident illuminance E.

The luminance correction unit 27 calculates a surface reflection luminance O [cd/m²] from the incident illuminance E (acquired at S23) and a surface reflection ratio S of the display 4 by an equation (7) (S24).

O=E×S/π (7)

In the equation (7), “S” is a variable changed within “0˜1” by depending on surface treatment of the display 4. In the third embodiment, “S” is set as a known constant value. In general, the display is defined as a luminous object and a reflection object. By reflecting the environmental light from a surface of the display, the surface reflection luminance occurs on the display. Accordingly, change of a surface luminance of the display 4 by incident environmental light can be correctly estimated.

The luminance correction unit 27 calculates a brightness response curve using the luminance distribution A of wide angle (acquired at S23), the display luminance Lₜ of each pixel (extracted at S21) and the surface reflection luminance O [cd/m²] (acquired at S24) (S25). In the third embodiment, the brightness response curve of an equation (8) is used.

R=Rₘ×(Lₜ+O)ⁿ/((Lₜ+O)ⁿ+Aⁿ) (8)

As to the third embodiment, in the same way as the first embodiment, the upper limit luminance L₁ and the lower limit luminance L₀, which corresponds to an upper limit Rₘₐₓ and a lower limit Rₘᵢₙ of the brightness response R respectively, are calculated by equations (9) and (10) each transformed from the equation (8). The upper limit Rₘₐₓ/Rₘ and the lower limit Rₘᵢₙ/Rₘ of the brightness response R is previously determined.

$$\begin{matrix}{L}_{0} = \frac{A}{{\{ ( {R}_{m} / {R}_{m i n} ) - 1 \}}^{1 / n}} - O & ( 4 ) \\ {L}_{1} = \frac{A}{{\{ ( {R}_{m} / {R}_{m a x} ) - 1 \}}^{\frac{1}{n}}} - O & ( 5 )\end{matrix}$$

In general, the surface reflection luminance of the display additionally acts upon the display luminance Lₜ of each pixel extracted from the video signal. Furthermore, maximum of the surface reflection luminance to be added is approximately 10 [cd/m²] in a bright visual environment (e.g. E=10000 [1×] and S=0.0033 [%]). Accordingly, as to a dark region (such as Lₜ<10 [cd/m²]) on the image, the display luminance Lₜ of each pixel acquired at S21 is largely different from an actual luminance on a surface of the display 4.

In the third embodiment, a brightness response curve suitable for the visual environment can be calculated using a display luminance (as a sum of Lₜ and the surface reflection luminance O) and the luminance distribution A of wide angle. As to a light-receiving element of the luminance distribution acquisition unit 200, a detectable luminance range is desired to be above 0.01 [cd/m²] and below 10000 [cd/m²]. However, by shifting the detectable luminance range based on the illuminance of the environmental light, the detectable luminance range may be desirably extended.

In this case, in synchronization with the incident illuminance E (detected by the incident illuminance detection unit 26) of the environmental light incident upon the display 4, by adjusting at least one or all of the stop value F, the shutter speed T [sec] and the ISO sensitivity S, the absolute luminance Labs (x, y) is desired to be calculated.

Especially, when the incident illuminance E is larger than a predetermined regular value, “F, T and S” are set as a smaller value. When the incident illuminance E is smaller than the predetermined regular value, “F, T and S” are set as a larger value. As a result, the luminance within a wider range can be acquired using a cheap light-receiving element (having a narrow response range), and the manufacture cost can be lowered.

As mentioned-above, as to the third embodiment, by using a surface reflection of the environmental light incident upon the display 4, the upper limit luminance and the lower limit luminance corresponding to the brightness perception range can be accurately calculated.

Other embodiments of the invention will be apparent to those skilled in the art from consideration of the specification and embodiments of the invention disclosed herein. It is intended that the specification and embodiments be considered as exemplary only, with the scope and spirit of the invention being indicated by the claims.

What is claimed is:

1. An image display apparatus comprising:
a display unit configured to display an image;
a calculation unit configured to calculate a display luminance from an input image;
a luminance distribution acquisition unit configured to take a scene image including the display unit from a view position of the display unit, and acquire a luminance distribution as an average of luminances of the scene image; and
a correction unit configured to correct the display luminance, so that a corrected display luminance is within an estimated luminance range of perceptible difference of luminances on the display unit;
wherein the estimated luminance range is estimated with the average, and
wherein the display unit displays the image based on the corrected display luminance.

2. The apparatus according to claim 1,
wherein the luminance distribution acquisition unit comprises an imaging sensor and a light focus unit configured to focus a light onto the imaging sensor.

3. The apparatus according to claim 2,
wherein the light focus unit comprises a wide-angle-lens.

4. The apparatus according to claim 2,
wherein the luminance distribution acquisition unit calculates the luminance distribution as a weighted average of luminances of the scene image taken from the imaging sensor.

5. The apparatus according to claim 4,
wherein the luminance distribution acquisition unit calculates the weighted average, so that a lower weight is assigned to the luminance in a region of the display unit in the scene image, and a higher weight is assigned to the luminance of an outside region in the scene image.

6. The apparatus according to claim 1,
wherein the luminance distribution acquisition unit takes the scene image taken from a view position of the display unit.

7. A system comprising a remote controller, and an image display apparatus including a display unit configured to display an image,
the remote controller comprising:
an operation unit configured to input a control signal to operate the image display apparatus in response to a viewer' s operation;
a luminance distribution acquisition unit configured to acquire a luminance distribution as an average of luminances of a scene image including the display unit, if the control signal is inputted; and
a transmission unit configured to transmit the control signal and the luminance distribution to the image display apparatus;
the image display apparatus comprising:
a display luminance calculation unit configured to calculate a display luminance from an input image;
a receiving unit configured to receive the control signal and the luminance distribution from the remote controller; and
a luminance correction unit configured to correct the display luminance based on the luminance distribution, so that a corrected display luminance is within an estimated luminance range of perceptible difference of luminances on the display unit;
wherein the estimated luminance range is estimated with average, and
wherein the display unit displays the image based on the corrected display luminance at a timing to execute the control signal.

8. The system according to claim 7,
wherein the luminance distribution acquisition unit takes the scene image at a timing to input the control signal.

9. The system according to claim 7,
wherein the luminance distribution acquisition unit is set on a surface of the remote controller on which the transmission unit is set.

10. The system according to claim 9,
wherein the luminance distribution acquisition unit comprises an imaging sensor and a light focus unit configured to focus a light onto the imaging sensor.

11. The system according to claim 10,
wherein the light focus unit comprises a wide-angle lens.

12. The system according to claim 10,
wherein the luminance distribution acquisition unit calculates the luminance distribution as a weighted average of luminances of the scene image taken from the imaging sensor.

13. The system according to claim 12,
wherein the luminance distribution acquisition unit calculates the weighted average, so that a lower weight is assigned to the luminance in a region of the display unit in the scene image, and a higher weight is assigned to the luminance of an outside region in the scene image.

14. The system according to claim 9,
wherein the image display apparatus comprises a detection unit configured to detect an incident illuminance of a light onto the display unit, and
wherein the luminance correction unit calculates a reflection luminance of the light reflected by the display unit, based on the incident illuminance, and calculates the corrected display luminance based on the reflection luminance and the luminance distribution.

15. The system according any of claim 7, further comprising:
a decision unit configured to decide whether the image displayed based on the control signal is above a specific standard;
wherein the display unit displays the image based on the corrected display luminance at the timing to execute the control signal, when the decision unit decides that the image displayed based on the control signal is above the predetermined standard.

16. A method in a remote controller and an image display apparatus including a display unit configured to display an image, comprising:
inputting a control signal to operate the image display apparatus;
acquiring a luminance distribution as an average of luminances of a scene image including the display unit, when the control signal is inputted; and
transmitting the control signal and the luminance distribution to the image display apparatus;
calculating a display luminance from an input image;
receiving the control signal and the luminance distribution from the remote controller;
correcting the display luminance based on the luminance distribution, so that a corrected display luminance is within an estimated luminance range of perceptible difference of luminances on the display unit, the estimated luminance range being estimated with the average; and
displaying the image based on the corrected display luminance at a timing to execute the control signal.
